(19) United States
(12) Patent Application Publication
(10) Pub. No.: US 2021/0357808 A1
(43) Pub. Date: Nov. 18, 2021

(54) MACHINE LEARNING MODEL GENERATION SYSTEM AND MACHINE LEARNING MODEL GENERATION METHOD

(71) Applicant: HITACHI, LTD., Tokyo (JP)

(72) Inventor: Masafumi TSUYUKI, Tokyo (JP)

(73) Assignee: HITACHI, LTD., Tokyo (JP)

(21) Appl. No.: 17/190,269

(22) Filed: Mar. 2, 2021

(30) Foreign Application Priority Data
May 14, 2020 (JP) 2020-085449

(51) Int. Cl. G06N 20/00; G06K 9/62

(52) U.S. Cl. CPC G06N 20/00; G06K 9/6215; G06K 9/6259; G06K 9/6227; G06K 9/6228

(57) ABSTRACT

A machine learning model generation system stores training data and a plurality of candidate models being machine learning models as selection candidates, performs machine learning by having the training data input into the candidate models to generate a plurality of trained models being trained machine learning models, classifies the trained models into a plurality of groups based on similarity of an inference result output by each of the trained models, generates an index used to select the group for each of the groups and selects the group based on the index that is generated, and sets the trained model belonging to the group that is selected as the candidate model. The machine learning model generation system repeatedly executes a series of processing of generating the learning model, classifying the group, selecting the group, and setting the candidate model until the number of candidate models becomes a predetermined number or less.

### CROSS-REFERENCE TO RELATED APPLICATION

This application claims priority pursuant to Japanese patent application No. 2020-085449, filed on May 14, 2020, the entire disclosure of which is incorporated herein by reference.

### BACKGROUND

### Technical Field

The present invention relates to a machine learning model generation system and a machine learning model generation method.

### Related Art

JP 2017-167834 A describes a training data selection device configured for the purpose of efficiently selecting training data having a high training effect and maintaining diversity in active learning that generates a discriminator. The training data selection device stores labeled training data to which a label that indicates a class is applied and unlabeled training data to which a label is not applied, uses a discriminator trained by the labeled training data to calculate an identification score with respect to the unlabeled training data, performs clustering of the unlabeled training data in a feature space in which a feature vector of the data is defined to generate multiple unlabeled clusters, selects a prescribed number of low reliability clusters that are close to an identification boundary of the discriminator from among the unlabeled clusters based on the identification score, and selects, for active learning, a prescribed equal allocation number of pieces of unlabeled training data from each of the low reliability clusters.

JP 2010-231768 A describes a method of training a multi-class classifier configured for the purpose of providing an active learning method that does not require a large amount of labeled training data for training the classifier. The multi-class classifier estimates the probability of class membership for unlabeled data acquired from an active pool of unlabeled data, obtains the difference between the largest and second largest probabilities and selects the unlabeled data having the smallest difference, applies a label to the selected unlabeled data, adds the labeled data to a training dataset, and trains the classifier using the training dataset.

A. Holub, P. Perona and MC Burl, “Entropy-based active learning for object recognition” (IEEE Computer Society Conference on Computer Vision and Pattern Recognition Workshops, Anchorage, A K, 2008, pp. 1-8) discloses a technique of selecting unlabeled data that minimizes information entropy expected after adding unlabeled data.

M. Sugiyama and N. Rubens, “A batch ensemble approach to active learning with model selection” (Neural Networks, 2008, pp. 1278-1286) discloses a technique for the purpose of solving a problem that model selection and active learning are incompatible, the technique reducing the bias of training data added in active learning by selecting unlabeled data that reduces the generalization error of the entire trained model set to be a selection candidate by active learning.

A. Ali, R. Caruana, and A. Kapoor, “Active Learning with Model Selection” (in Proceedings of the Twenty-Eighth AAAI Conference on Artificial Intelligence, 2014, pp. 1673-1679) discloses a technique that not only reduces the generalization error of a trained model set but that also selects a test data by which a trained model with low generalization error can be selected, in order to reduce the bias of model selection.

In recent years, efforts for automation utilizing machine learning have been promoted in various fields such as medical image diagnosis, automatic driving, and material design. Automation by machine learning is carried out by regarding issues in each field as classification problems and regression problems. For example, in the application to medical image diagnosis, a classification model is utilized to narrow down images that may contain disease and to support the work of medical professionals such as doctors. Further, for example, in the application to material design, a regression model is utilized to predict physical property values according to the structure of the material.

In the classification by machine learning, a feature quantity as a classification target is input to a classification model, and a classification probability for each class of the classification destination is obtained as an output. In the regression by machine learning, a feature quantity as a regression target is input to a regression model, and a real value of an object variable is obtained as an output. Supervised learning is generally applied to the generation of models for regression and classification. In the supervised learning, parameters of the model are optimized by learning using training data consisting of a pair of feature quantity and object variable.

In order to generate a model with high generalization performance, a large amount of training data covering the data distribution to be a potential target of inference is required. In creating the training data, a work called annotation of acquiring an object variable according to a feature quantity is required, which requires a large amount of manpower and cost. For example, in the above example of medical image diagnosis, it is necessary for a doctor to check diagnostic images one by one and classify the presence/absence of a disease. Further, in the example of material design, it is necessary for a designer to perform experiments and simulations to obtain physical property values according to the structure of the material.

There is a technique called active learning as a method of reducing the load on creating training data. In the active learning, first, a model is generated based on a small number of pieces of available training data, unlabeled data is input to the generated model to perform inference, and based on the inference result, the unlabeled data that is difficult to infer by the model is selected as an annotation target. Next, an oracle (subject such as a person, an arbitrary machine, or a program performing discrimination) annotates the selected unlabeled data, and the data in which the object variable (label) set by the oracle is associated with the unlabeled data is added as the training data. Then, the added training data is input to the model to perform re-training, and test data is input to the trained model to evaluate the generalization performance. In the active learning, the addition of the training data and the re-training as described above are repeatedly performed until the generalization performance of the model reaches a desired level.

In the above active learning, it is necessary to appropriately select the unlabeled data. For example, in A. Holub, P. Perona and MC Burl, “Entropy-based active learning for object recognition”, unlabeled data is selected so as to minimize the expected information entropy after adding the unlabeled data. Further, in JP 2017-167834 A, unlabeled data belonging to a cluster near the classification boundary of the classification model is selected, and training data covering various types of unlabeled data is generated. Further, in JP 2010-231768 A, active learning of multi-class classification is performed using information entropy as an index for quantifying uncertainty by a classification model. On the other hand, the optimum model for the problem to be solved is often unknown, and usually, a technique called “model selection” is used, in which training is performed on a plurality of candidate models with varying algorithms and hyperparameters, and the model with the highest generalization performance is selected. In the active learning, because unlabeled data that is difficult to infer by the model is selected as the annotation target, it is known that the model selection is incompatible with the active learning.

Now, for example, consider the case in which, firstly, a small amount of training data is input and a model with high accuracy is selected, and thereafter, the amount of training data is increased by active learning. In this case, biased training data is generated by the active learning, the biased training data causing the accuracy to be improved for the trained model being a local solution selected by a small amount of training data, and improvement in the generalization performance of the trained model cannot be guaranteed. In addition, when the model selection is performed using the biased training data generated by the active learning, a model that correctly reflects the generalization performance in the actual environment will not always be selected. It is also conceivable to execute the active learning and the model selection alternately, but in that case, the model selected in each time of the model selection does not become constant, and the load on creating the training data cannot be sufficiently reduced.

In order to solve the above problem that the model selection and the active learning are incompatible, in M. Sugiyama and N. Rubens, “A batch ensemble approach to active learning with model selection”, the unlabeled data that reduces the generalization error of the entire trained model set to be the selection candidate is selected by active learning to reduce the bias of the training data added by the active learning. Further, in A. Ali, R. Caruana, and A. Kapoor, “Active Learning with Model Selection”, the bias of model selection is reduced by not only reducing the generalization error of the trained model set but also by selecting the test data by which the trained model with low generalization error can be selected. However, for example, when the trained model set is highly diverse, when these techniques are applied, it is necessary to prepare various types of training data in order to reduce generalization error, and even if the active learning is performed, the number times of annotation cannot be sufficiently reduced.

### SUMMARY

The present invention has been made in view of such a background, and it is an object of the present invention to provide a machine learning model generation system and a machine learning model generation method that can efficiently generate a learning model with high inference accuracy while suppressing the load on generating training data.

One aspect of the present invention for achieving the above object is a machine learning model generation system configured by an information processing device and including: a storage unit configured to store training data and a plurality of candidate models being machine learning models to be selection candidates; a training execution unit configured to perform machine learning by having the training data input into the candidate models to generate a plurality of trained models being trained machine learning models; a grouping unit configured to classify the trained models into a plurality of groups based on similarity of an inference result output by each of the trained models; a group selection unit configured to generate an index used to select the group for each of the groups and select the group based on the index that is generated; and a candidate model set setting unit configured to set the trained model belonging to the group that is selected, as the candidate model.

According to the present invention, it is possible to efficiently generate a learning model with high inference accuracy while suppressing the load on generating training data.

The problems, configurations, and effects other than those described above will be clarified by the following description of the embodiment for carrying out the invention.

### BRIEF DESCRIPTION OF THE DRAWINGS

FIG. 1 is a diagram showing a schematic configuration of a machine learning model generation system;

FIG. 2 is a diagram showing a hardware configuration example of an information processing device used to configure the machine learning model generation system;

FIG. 3 is a diagram illustrating a schematic operation of the machine learning model generation system;

FIG. 4 is a system flow diagram illustrating the main functions provided in the machine learning model generation system;

FIG. 5 is an example of training data;

FIG. 6 is an example of unlabeled data;

FIG. 7 is an example of a candidate model set;

FIG. 8 is an example of trained model set information;

FIG. 9 is an example of group configuration information;

FIG. 10 is an example of group selection information;

FIG. 11 is a flowchart illustrating trained model selection processing;

FIG. 12 is a flowchart illustrating group classification selection processing;

and

FIG. 13 is a flowchart illustrating training processing.

### DESCRIPTION OF EMBODIMENTS

Hereinafter, an embodiment of the present invention is described with reference to the accompanying drawings. The following description and drawings are exemplifications for explaining the present invention, and are, as necessary, omitted and simplified to clarify the description. The present invention can be implemented in various other forms. Unless otherwise specified, each component may be singular or plural.

In the following description, various types of data may be described by the expression “information”, but various types of data may be expressed by other data structures such as tables and lists. Further, when the description is made regarding the identification information, expressions such as “identifier” and “ID” are used, but these can be replaced with each other. Further, in the following description, the letter “S” added before the code means a processing step.

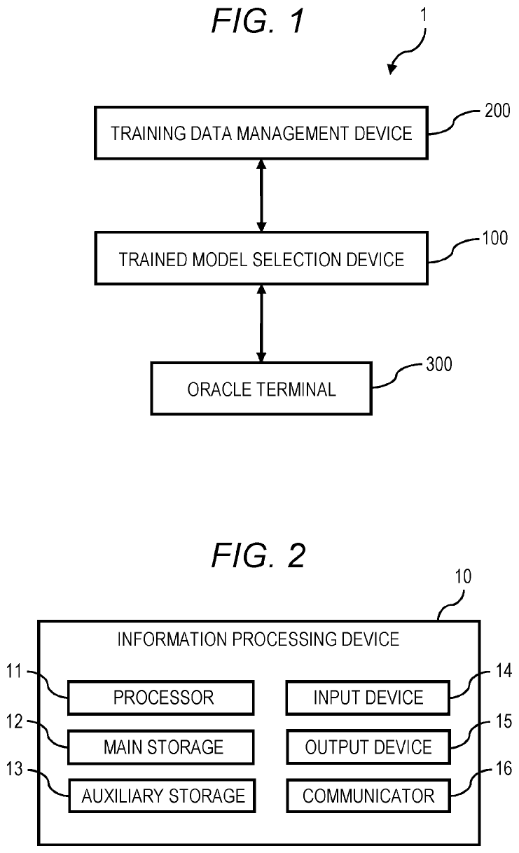

FIG. 1 shows a schematic configuration of an information processing system (hereinafter, referred to as a “machine learning model generation system 1”) shown as one embodiment. As shown in the drawing, the machine learning model generation system 1 includes a trained model selection device 100, a training data management device 200, and an oracle terminal 300. All of the above are configured using an information processing device (computer). The trained model selection device 100, the training data management device 200, and the oracle terminal 300 are communicatively connected to each other at least to the extent necessary via wired or wireless communication infrastructures (Local Area Network (LAN), Wide Area Network (WAN)), the Internet, a public communication network, a dedicated line, Wi-Fi (registered trademark), Bluetooth (registered trademark), Universal Serial Bus (USB), an internal bus (Bus), and others.

FIG. 2 shows an example of the information processing device used to configure the trained model selection device 100, the training data management device 200, and the oracle terminal 300. As shown in the figure, an exemplified information processing device 10 includes a processor 11, a main storage 12, an auxiliary storage 13, an input device 14, an output device 15, and a communicator 16. The information processing device 10 may be the one realized using virtual information processing resources, such as a virtual server provided by a cloud system, provided in whole or in part by using such as the virtualization technology or the process space separation technology. Further, the functions provided by the information processing device 10 may be realized in whole or in part by such as a service provided by a cloud system via an Application Programming Interface (API) or the like. Further, the trained model selection device 100, the training data management device 200, and the oracle terminal 300 may be configured by using a plurality of information processing devices 10 communicatively connected with each other.

In the drawing, the processor 11 is configured by using, for example, a Central Processing Unit (CPU), a Micro Processing Unit (MPU), a Graphics Processing Unit (GPU), a Field Programmable Gate Array (FPGA), an Application Specific Integrated Circuit (ASIC), an Artificial Intelligence (AI) chip, or others.

The main storage 12 is a device that stores programs and data, and is, for example, a Read Only Memory, (ROM), a Random Access Memory (RAM), a Non-Volatile Memory (Non-Volatile RAM (NVRAM)), or others.

The auxiliary storage 13 is, for example, a Solid State Drive (SSD), a hard disk drive, an optical storage (Compact Disc (CD), Digital Versatile Disc (DVD), etc.), a storage system, a reading/writing device for a recording medium such as an Integrated Circuit (IC) card, a Secure Digital (SD) card, and an optical recording medium, a storage area for a cloud server, or others. Programs and data can be read into the auxiliary storage 13 via a reading device of a recording medium or the communicator 16. The programs and data stored in the auxiliary storage 13 are read into the main storage 12 as needed. The auxiliary storage 13 constitutes a function of storing various types of data (hereinafter, referred to as a “storage unit”).

The input device 14 is an interface that accepts input from the outside, and is, for example, a keyboard, a mouse, a touch panel, a card reader, a pen input tablet, a voice input device, or others.

The output device 15 is an interface that outputs various information such as processing progress and processing results. The output device 15 is, for example, a display device (liquid crystal monitor, Liquid Crystal Display (LCD), graphic card, etc.) that visualizes the above various information, a device (audio output device (speaker, etc.)) that converts the above various information to voice, or a device (printing device, etc.) that converts the above various information into characters. In addition, for example, the information processing device 10 may be configured to input and output information to and from another device via the communicator 16.

The input device 14 and the output device 15 form a user interface for receiving and presenting the information from and to the user.

The communicator 16 is a device that realizes communication with other devices. The communicator 16 is a wired or wireless communication interface that realizes communication with other devices via a communication network (the Internet, LAN, WAN, a dedicated line, a public communication network, etc.) and for example, is a Network Interface Card (NIC), a wireless communication module, a Universal Serial Bus (USB) module, or others.

The information processing device 10 may be introduced with an operating system, a file system, a DataBase Management System (DBMS) (relational database, NoSQL, etc.), a Key-Value Store (KVS), or others.

The various functions of the trained model selection device 100, the training data management device 200, and the oracle terminal 300 can be realized by the processor 11 reading and executing the program stored in the main storage 12, or by the hardware (FPGA, ASIC, AI chip, etc.) that constitutes the above devices. The trained model selection device 100, the training data management device 200, and the oracle terminal 300 store various information (data) as, for example, a database table or a file managed by a file system.

Note that the trained model selection device 100, the training data management device 200, and the oracle terminal 300 may be realized by independent information processing devices, or by the common information processing device constituted by communicatively connecting two or more of the above devices.

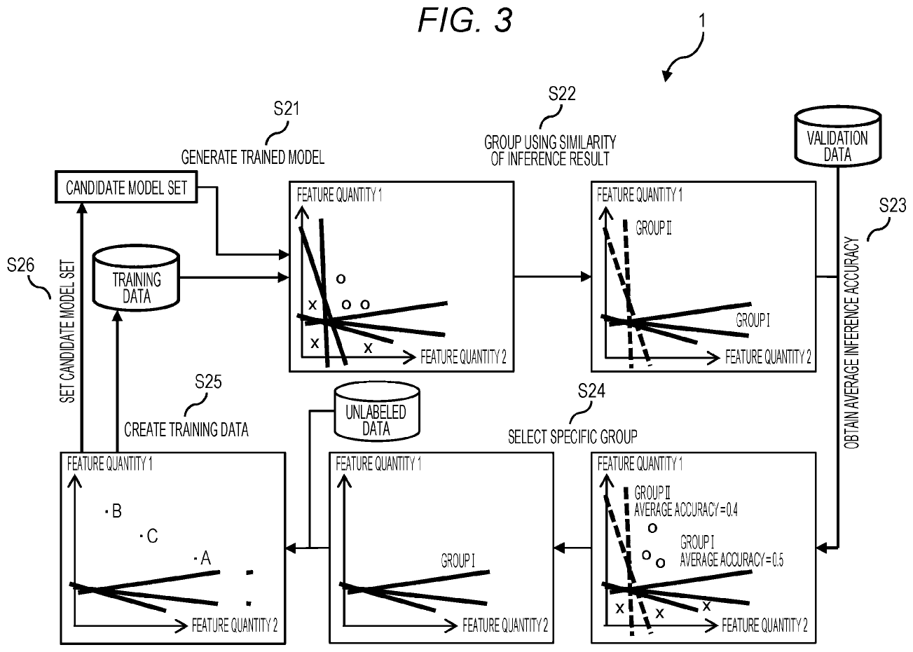

FIG. 3 is a diagram illustrating a schematic operation of the machine learning model generation system 1. Hereinafter, the description is made together with the drawing. Graphs shown in the drawing are all schematic representations of the learning model using two-dimensional feature quantities.

The machine learning model generation system 1 uses training data being labeled data to learn a learning model of a candidate model set (hereinafter, referred to as the “candidate model”), and generates a trained machine learning model (hereinafter, referred to as the “trained model”) (S21). The learning model used in the machine learning model generation system 1 is, for example, a machine learning model for learning using training data in a framework of supervised learning, such as a classification model in which feature quantities are input and classified into classes represented by an object variable, or a regression model in which feature quantities to be regressed are input and output as real values of the object variable. However, the type of learning model is not necessarily limited.

Subsequently, the machine learning model generation system 1 classifies the generated trained models into a plurality of groups based on similarity of inference results (S22).

Subsequently, the machine learning model generation system 1 obtains, for each classified group, an index for selecting a specific group from among the groups (S23).

Subsequently, the machine learning model generation system 1 selects a specific group based on the obtained index (S24).

Subsequently, the machine learning model generation system 1 selects, from among the unlabeled data, the one that is expected to improve the average inference accuracy by performing active learning (see, for example, M. Sugiyama and N. Rubens, “A batch ensemble approach to active learning with model selection” and A. Ali, R. Caruana, and A. Kapoor, “Active Learning with Model Selection”) for the trained model set of the selected group, and then prompts the oracle (subject such as a person, an arbitrary machine, or a program performing discrimination) to annotate (set the object variable (label)) for the selected unlabeled data. The machine learning model generation system 1 acquires the object variable of the unlabeled data from the oracle and adds a set of the unlabeled data and the object variable as the training data (S25).

Subsequently, the machine learning model generation system 1 sets the trained model of the selected group as the candidate model (S26).

In this way, the machine learning model generation system 1 classifies the trained models into the plurality of groups based on the similarity of the inference results output by each of the trained models, selects the group based on the index generated for each group, performs re-training with the trained model belonging to the selected group as the candidate model, and specifies the learning model having the high inference accuracy. In addition, the system performs the active learning on the trained model belonging to the selected group to select the unlabeled data, and adds additional data, which is data that associates the selected unlabeled data with the object variable acquired from the oracle, to the training data. Therefore, the user can generate a highly accurate trained model without preparing a large amount of training data in advance.

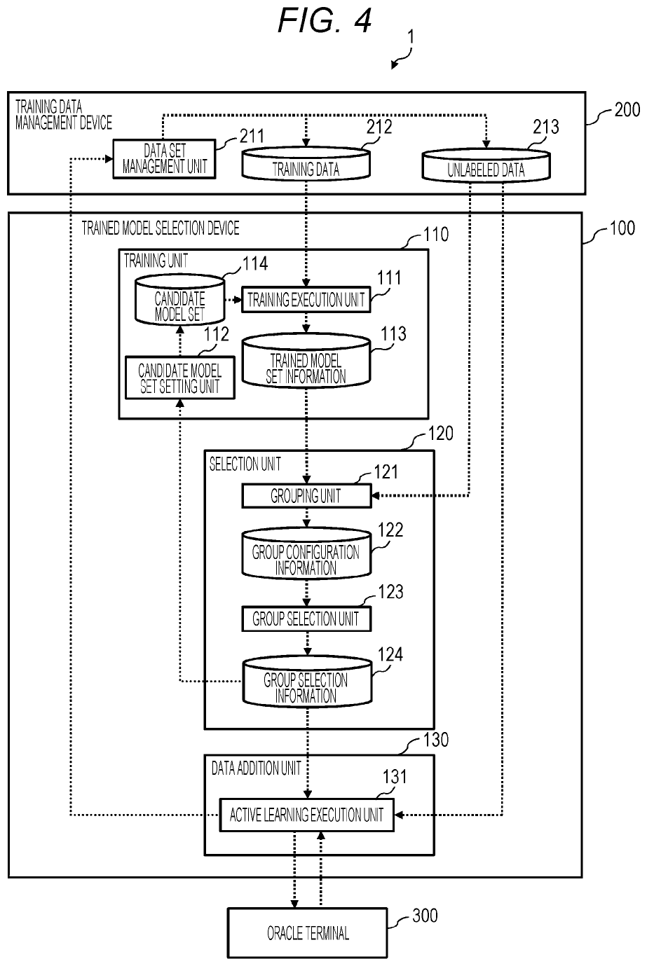

FIG. 4 is a diagram explaining the operation of the machine learning model generation system 1 shown in FIG. 3 in more detail, and is a system flow diagram explaining the main functions of the machine learning model generation system 1. Hereinafter, each function is described in detail together with the drawing.

As shown in the drawing, the training data management device 200 includes the data set management unit 211. Further, the training data management device 200 stores training data 212 and unlabeled data 213. The data set management unit 211 manages the training data 212 and the unlabeled data 213 (for example, adds, deletes, activates, or invalidates data). In addition, the data set management unit 211 provides (transmits) the training data 212 and the unlabeled data 213 to the trained model selection device 100 as needed. Further, the data set management unit 211 adds the training data 212 based on information transmitted from a data addition unit 130. In the following description, it is assumed that the training data management device 200 stores in advance at least a number of pieces of the training data 212 required for the processing described below and a predetermined number of pieces of the unlabeled data 213.

As shown in the figure, the trained model selection device 100 includes the functions of a training unit 110, a selection unit 120, and the data addition unit 130.

The training unit 110 includes the functions of a training execution unit 111 and a candidate model set setting unit 112. Further, the training unit 110 stores trained model set information 113 and a candidate model set 114.

The candidate model set 114 contains information on the candidate model. The training execution unit 111 acquires the training data 212 from the training data management device 200, inputs the acquired training data 212 into the candidate model of the candidate model set 114 and performs training of the candidate model to generate a trained model, and stores parameters of the generated trained model in the trained model set information 113. The candidate model set setting unit 112 updates the candidate model set 114 based on the information of the group selected by the selection unit 120. When group selection information 124 is updated, the candidate model set setting unit 112 updates the candidate model set 114 so that, for example, the candidate model corresponding to the trained model of the group selected by the selection unit 120 becomes valid. Further, when the group selection information 124 is updated, the candidate model set setting unit 112 updates the candidate model set 114 so that, for example, the candidate model corresponding to the trained model of the group selected by the selection unit 120 becomes valid, and the trained models of other than the above group become invalid.

The selection unit 120 includes the functions of a grouping unit 121 and a group selection unit 123. Further, the selection unit 120 stores group configuration information 122 and the group selection information 124. The grouping unit 121 acquires the inference result of each trained model by inputting the unlabeled data 213 acquired from the training data management device 200 into each trained model of the trained model set information 113 and performing inference, and obtains the similarity (mutual information, Kullback-Leibler information, Jensen-Shannon information, etc.) of the acquired inference results. On the basis of the above similarity, the grouping unit 121 classifies the trained models of the trained model set information 113 into a plurality of groups by a known classification method (hierarchical clustering, spectral clustering, etc.), and stores the results in the group selection information 124.

The group selection unit 123 obtains the above index for each of the groups of the group configuration information 122, selects a specific group based on the obtained index, and reflects the selected result in the group selection information 124. As the above index, for example, the average inference accuracy of the trained models belonging to the group is used. Further, as the above index, for example, the amount of increase in the average inference accuracy of the trained models belonging to the group when the data addition unit 130 adds the training data may be used. For example, in the case of the trained model being a classification model, the inference accuracy is a correct rate, a precision rate, a recall rate, an F value, or others. If the learning model is a regression model, the inference accuracy is a mean square error (MSE), a root mean square error (RMSE), a coefficient of determination (R2), or others.

The data addition unit 130 includes the function of an active training execution unit 131. The active training execution unit 131 selects the unlabeled data 213 that can improve the accuracy of the trained model of the group selection information 124 by, for example, the methods described in M. Sugiyama and N. Rubens, “A batch ensemble approach to active learning with model selection” and A. Ali, R. Caruana, and A. Kapoor, “Active Learning with Model Selection”. In addition, the data addition unit 130 transmits the selected unlabeled data 213 to the oracle terminal 300. The oracle terminal 300 presents the transmitted selected unlabeled data 213 to the oracle, accepts the input of the object variable corresponding to the unlabeled data from the oracle, and transmits the accepted object variable to the data addition unit 130. The active training execution unit 131 receives the object variable transmitted from the oracle terminal 300, generates training data in which the unlabeled data is associated with the received object variable, and transmits the training data to the data set management unit 211 of the training data management device 200. The data set management unit 211 stores the transmitted training data as the training data 212. Further, the data set management unit 211 deletes the unlabeled data constituting the above training data from the unlabeled data 213.

Next, various information (data) managed in the machine learning model generation system 1 is described.

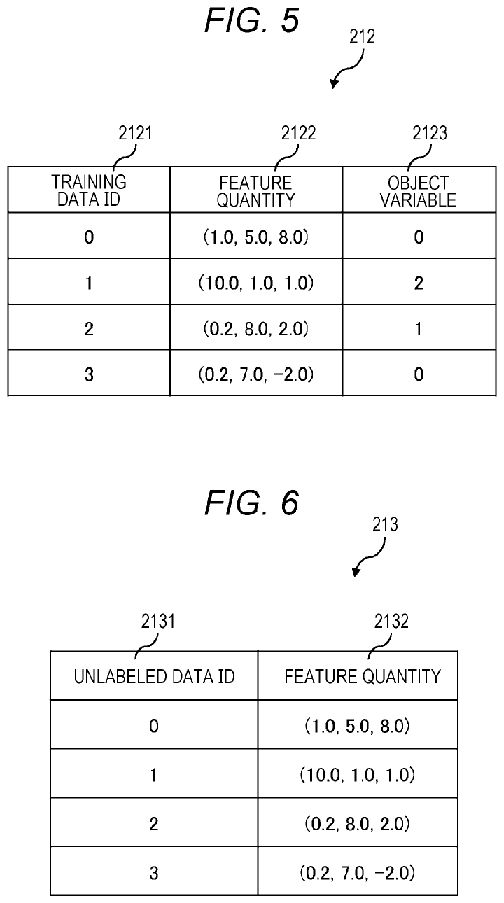

FIG. 5 shows an example of the training data 212. As shown in the figure, the exemplified training data 212 is constituted of one or more entries (records) each having items which are a training data ID 2121, a feature quantity 2122, and an object variable 2123. One of the entries of the training data 212 corresponds to one piece of training data.

Among the above items, a training data ID (numerical value, character string, etc.) which is an identifier of the training data is set in the training data ID 2121. A feature quantity, which is an element of the training data, is set in the feature quantity 2122. The feature quantity is a value indicating the feature of data to be inferred or data generated from the data to be inferred, and is represented by, for example, a character string, a numerical value, a vector, or others. In the object variable 2123, the object variable (for example, a label indicating a class to be classified, data indicating the correct answer, etc.) of the training data is set.

FIG. 6 shows an example of the unlabeled data 213. As shown in the drawing, the exemplified unlabeled data 213 is constituted of one or more entries (records) each having items which are an unlabeled data ID 2131 and a feature quantity 2132. One of the entries of the unlabeled data 213 corresponds to one piece of the unlabeled data 213.

Among the above items, an unlabeled data ID (numerical value, character string, etc.) which is an identifier of the unlabeled data is set in the unlabeled data ID 2131. A feature quantity, which is an element of the unlabeled data, is set in the feature quantity 2132. The feature quantity is a value indicating the feature of data to be inferred or data generated from the data to be inferred, and is represented by, for example, a character string, a numerical value, a vector, or others.

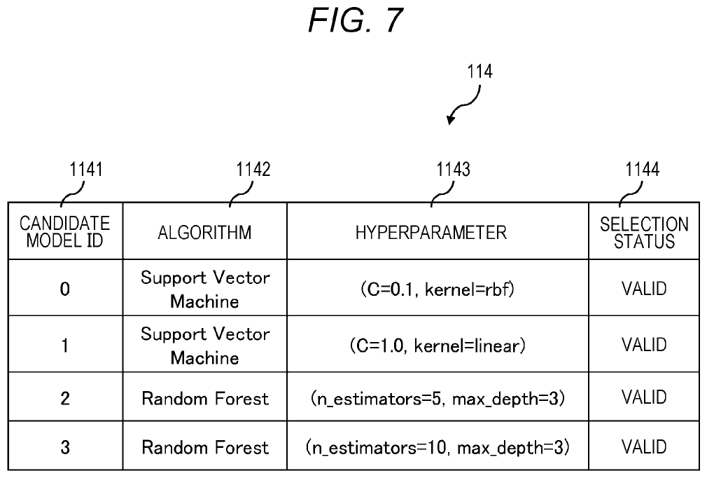

FIG. 7 shows an example of the candidate model set 114. As shown in the drawing, the candidate model set 114 is constituted of one or more entries (records) each having items which are a candidate model ID 1141, algorithm 1142, a hyperparameter 1143, and a selection status 1144. One of the entries in the candidate model set 114 corresponds to one candidate model.

Among the above items, a candidate model ID (numerical value, character string, etc.) which is an identifier of the candidate model is set in the candidate model ID 1141. Information regarding algorithm (algorithm type, algorithm (such as determinant, vector, numerical value), etc.) constituting the candidate model is set in the algorithm 1142. Types of algorithm include, for example, decision trees, Random Forest, and Support Vector Machine (SVM). Hyperparameters used with the algorithm are set in the hyperparameter 1143. Information indicating whether or not the candidate model is currently valid is set in the selection status 1144. The candidate model set 114 may further contain other information related to the candidate model as well as the algorithm and hyperparameters.

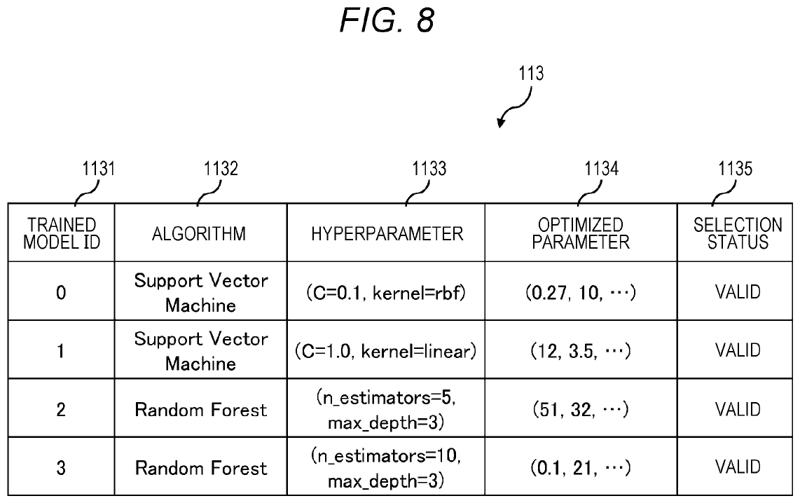

FIG. 8 shows an example of the trained model set information 113. As shown in the figure, the trained model set information 113 is constituted of one or more entries (records) each having items which are a trained model ID 1131, algorithm 1132, a hyperparameter 1133, an optimized parameter 1134, and a selection status 1135. One of the entries in the trained model set information 113 corresponds to one trained model.

Among the above items, a trained model ID (numerical value, character string, etc.), which is an identifier of the trained model, is set in the trained model ID 1131. The trained model ID is associated with the candidate model ID, and may be shared with, for example, the candidate model ID. Information regarding the algorithm that constitutes the trained model is set in the algorithm 1132. The above information is similar to the algorithm 1142 of the candidate model set 114 described above. Hyperparameters used with the algorithm are set in the hyperparameters 1133. The optimized parameters (determinant, vector, numerical value, etc.) being entities of the trained model are set in the optimized parameter 1134. Information indicating whether or not the trained model is currently valid is set in the selection status 1135.

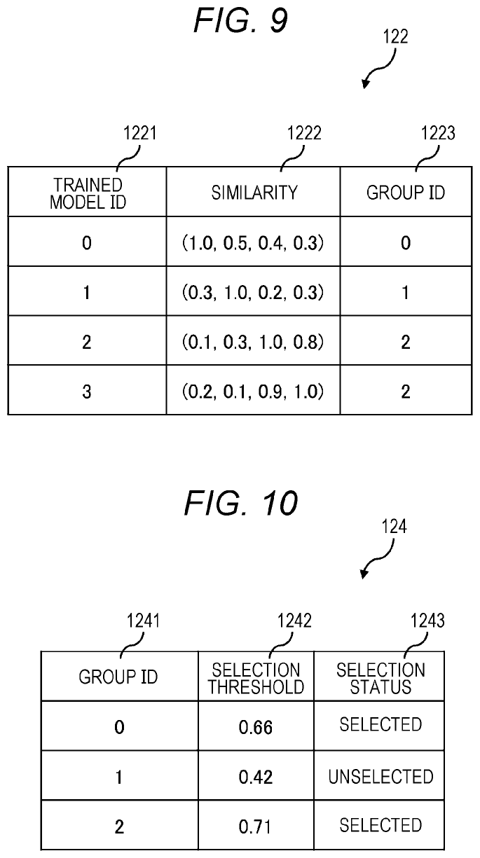

FIG. 9 shows an example of the group configuration information 122. As shown in the figure, the group configuration information 122 is constituted of one or more entries (records) each having items which are a trained model ID 1221, similarity 1222, and a group ID 1223. One of the entries in the group configuration information 122 corresponds to one trained model.

Among the above items, a trained model is set in the trained model ID 1221. The above-described similarity is set in the similarity 1222. In this example, a vector indicating the similarity between the trained model and another trained model is set in the similarity 1222. In the case of the exemplified group configuration information 122, for example, a vector “(1.0, 0.5, 0.4, 0.3)” in the first row indicates that: the similarity between a trained model with the trained model ID of “0” and a trained model with the trained model ID of “0” is “1.0”; the similarity between the trained model with the trained model ID of “0” and a trained model with the trained model ID of “1” is “0.5”; the similarity between the trained model with the trained model ID of “0” and a trained model with the trained model ID of “2” is “0.4”; and the similarity between the trained model with the trained model ID of “0” and a trained model with the trained model ID of “3” is “0.3”. A group ID (numerical value, character string, etc.), which is an identifier of the group to be classified of the trained model, is set in the group ID 1223.

FIG. 10 shows an example of the group selection information 124. As shown in the figure, the group selection information 124 is constituted of one or more entries (records) each having items which are a group ID 1241, a selection threshold 1242, and a selection status 1243. One of the entries in the group selection information 124 corresponds to one group.

Among the above items, a group ID is set in the group ID 1241. The above-described index obtained for the group is set in the selection threshold 1242. Information indicating whether or not the group is currently selected is set in the selection status 1243.

Next, processing performed in the machine learning model generation system 1 is described.

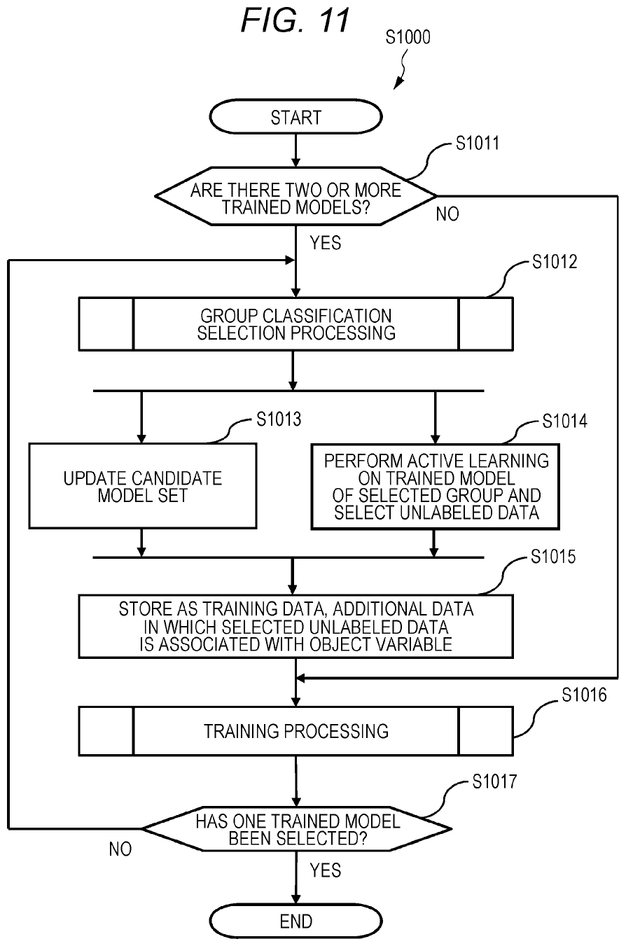

FIG. 11 is a flowchart illustrating the processing performed by the machine learning model generation system 1 (hereinafter, referred to as “trained model selection processing S1000”). The trained model selection processing S1000 is started, for example, by accepting a learning model generation instruction from the user. At the start of the trained model selection processing S1000, it is assumed that the training data management device 200 stores in advance at least a number of pieces of the training data 212 required for the processing described below and a predetermined number of pieces of unlabeled data 213. Further, it is assumed that the contents are set in advance in the candidate model set 114 of the trained model selection device 100.

As shown in the drawing, the training unit 110 first confirms whether or not there are two or more currently valid trained models in the trained model set information 113 (S1011). If there is only one currently valid trained model in the trained model set information 113 (S1011: NO), the processing proceeds to S1016. On the other hand, if there are two or more currently valid trained models in the trained model set information 113 (S1011: YES), the processing proceeds to S1012. In the following, two or more currently valid trained models stored in the trained model set information 113 are referred to as a trained model set.

In S1012, the selection unit 120 of the trained model selection device 100 classifies the trained model set into a plurality of groups by the method described above, and meanwhile, selects a specific group from the classified groups, and performs the processing that reflects the selected result to the group selection information 124 (hereinafter referred to as “group classification selection processing S1012”). The details of the group classification selection processing S1012 are described later.

When the group classification selection processing S1012 is executed, the candidate model set setting unit 112 of the training unit 110 subsequently updates the candidate model set 114 based on the group configuration information 122 and the group selection information 124 (S1013). Specifically, for example, for a candidate model corresponding to the trained model belonging to the group whose selection status 1213 of the group selection information 124 is set to “selected” (hereinafter, referred to as “selected group”), the candidate model set setting unit 112 sets the selection status 1144 of the candidate model to “valid” and stores the setting in the candidate model set 114, and further, for a candidate model corresponding to the trained model belonging to the group whose selection status 1213 of the group selection information 124 is set to “unselected”, the candidate model set setting unit 112 sets the selection status 1144 of the candidate model to “invalid”.

Further, the data addition unit 130 of the selection unit 120 selects the unlabeled data 213 from the training data management device 200 by performing active learning on the trained model belonging to the selected group, and transmits the selected unlabeled data 213 to the oracle terminal 300. The oracle terminal 300 accepts the object variable of the transmitted unlabeled data 213 from the oracle, and returns the accepted object variable to the data addition unit 130. The data addition unit 130 generates additional data by associating the object variable received from the oracle terminal 300 with the unlabeled data 213, and transmits the generated additional data to the training data management device 200 (S1014).

The data set management unit 211 of the training data management device 200 receives additional data from the data addition unit 130, and stores the received additional data as the training data 212 (S1015). Further, the data set management unit 211 invalidates the unlabeled data 213 that is the constituent source of the received additional data.

Subsequently, the training unit 110 inputs the training data 212 into the candidate model of the candidate model set 144 to perform training of the candidate model (hereinafter, referred to as “training processing S1016”). At this time, the training unit 110 may have only the candidate models of the candidate model set 144 whose selection status 1144 is set to “valid” as the subject of training, or all the candidate models of the candidate model set 144 as the subject of training. Details of the training processing S1016 are described later.

Subsequently, the trained model selection device 100 determines whether or not one trained model has been selected (whether or not one selected group is selected and there is only one trained model belonging to the selected group). If one trained model is selected (S1017: YES), the processing is terminated. On the other hand, if one trained model is not selected (S1017: NO), the processing returns to S1012.

In the above, the processing from S1012 is repeated until one trained model is selected, but the trained model selection processing S1000 may be terminated at the stage when the trained models are narrowed down to a predetermined number of trained models belonging to the selected group (which may be two or more).

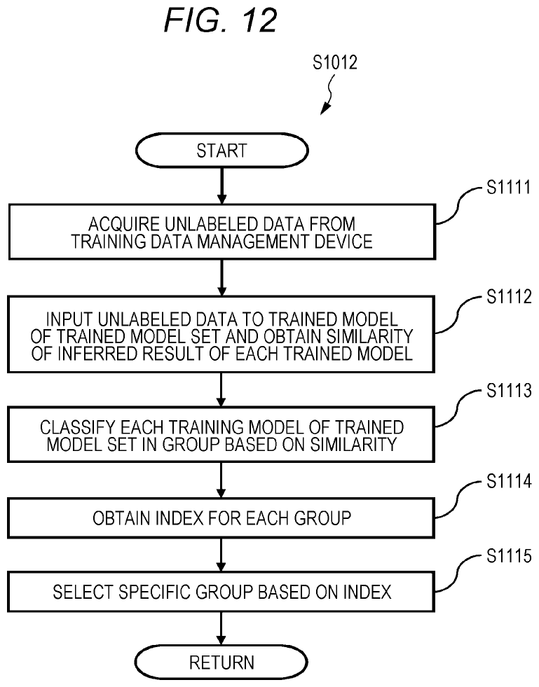

FIG. 12 is a flowchart illustrating the details of the group classification selection processing S1012 shown in FIG. 11. Hereinafter, the group classification selection processing S1012 is described with reference to the drawing.

First, the selection unit 120 acquires unlabeled data from the training data management device 200 (S1111).

Subsequently, the selection unit 120 inputs the unlabeled data 213 into each trained model of the trained model set information 113 input from the training unit 110, performs inference using each learning model, and obtains the similarity of the inference result of each trained model (S1112).

Subsequently, the selection unit 120 classifies the trained models stored in the trained model set information 113 into groups based on the obtained similarities (S1113).

Subsequently, the selection unit 120 obtains the above-described index for selecting a specific group from these groups, for each classified group (S1114).

Subsequently, the selection unit 120 selects a specific group based on the index, and sets the selection result (“selected” or “unselected”) in the selection status 1243 of the group selection information 124 (S1115). The selection unit 120 makes the above selection, for example, by selecting a predetermined number of groups from those having a high index (average inference accuracy). This completes the group classification selection processing S1012.

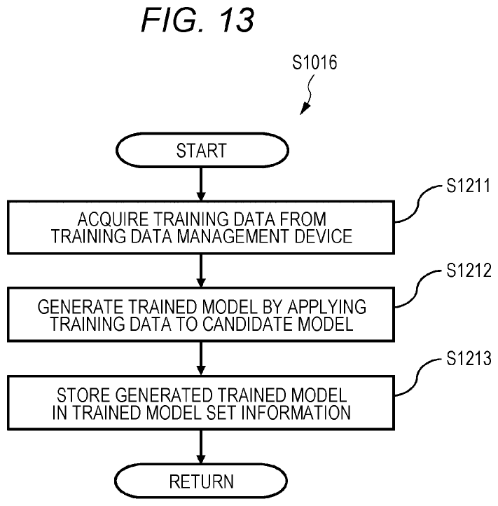

FIG. 13 is a flowchart illustrating the details of the training processing S1016 shown in FIG. 11. The training processing S1016 is described below together with the drawing.

First, the training unit 110 acquires the training data 212 from the training data management device 200 (S1211).

Subsequently, the training unit 110 inputs the training data 212 into each candidate model of the candidate model set 114 to generate (learn) a learning model based on each candidate model (S1212).

Then, the training unit 110 stores the generated trained model in the trained model set information 113 (S1213). This completes the training processing S1016.

As described above, the machine learning model generation system 1 of the present embodiment classifies the trained models into a plurality of groups based on the similarity of the inference result output by each of the trained models that is trained by having the training data input into the candidate model, selects the group based on the index generated for each group, performs re-training of the trained model belonging to the selected group as the candidate model, and specifies (narrows down) the learning model having a high inference accuracy. Therefore, the trained model having high accuracy can be generated without preparing for a large amount of training data.

Further, the machine learning model generation system 1 of the present embodiment selects a specific piece of unlabeled data from a plurality of pieces of unlabeled data by performing the active learning on the trained model belonging to the selected group, and adds the additional data being data in which the selected unlabeled data is associated with the object variable acquired from the oracle for the unlabeled data, to the training data.

As described above, according to the machine learning model generation system 1 of the present embodiment, it is possible to efficiently generate a learning model with high inference accuracy while suppressing the load on creating the training data.

Although one embodiment of the present invention has been described above, it is needless to say that the present invention is not limited to the above-described embodiment and can be variously modified without departing from the gist thereof. For example, the above-described embodiment has been described in detail in order to explain the present invention in an easy-to-understand manner, and is not necessarily limited to the one including all the configurations described. Further, a part of the configuration of the embodiment can be deleted, or added or replaced with another configuration.

Moreover, each of the above-described configurations, functional units, processing units, processing means, and the like may be realized in part or in whole by hardware by designing using such as an integrated circuit. Further, each of the above-described configurations, functions, and others may be realized by software by such as a processor interpreting and executing a program for realizing each of the functions. The information such as a program, a table, and a file that realize each of the functions can be placed in a recording device such as a memory, a hard disk, or an SSD, or in a recording medium such as an IC card, an SD card, or a DVD.

Further, the arrangement form of various functional units, various processing units, and various databases of each information processing device described above is only an example. The arrangement form of various functional units, various processing units, and various databases can be changed to the optimum arrangement form from viewpoints such as the performance, processing efficiency, and communication efficiency of the hardware and software included in these devices.

In addition, the configuration of the database (schema, etc.) for storing various types of data described above can be flexibly changed from viewpoints such as efficient use of resources, improvement of processing efficiency, improvement of access efficiency, and improvement of search efficiency.

What is claimed is:

1. A machine learning model generation system configured by an information processing device, comprising:
a storage unit configured to store training data and a plurality of candidate models being machine learning models to be selection candidates;
a training execution unit configured to perform machine learning by having the training data input into the candidate models to generate a plurality of trained models being trained machine learning models;
a grouping unit configured to classify the trained models into a plurality of groups based on similarity of an inference result output by each of the trained models;
a group selection unit configured to generate an index used to select the group for each of the groups and select the group based on the index that is generated; and
a candidate model set setting unit configured to set the trained model belonging to the group that is selected, as the candidate model.

2. The machine learning model generation system according to claim 1, wherein
the storage unit further stores a plurality of pieces of unlabeled data,
the group selection unit selects a specific piece of unlabeled data from the plurality of pieces of unlabeled data by performing active learning on the trained model belonging to the selected group, and
the machine learning model generation system further comprises a data addition unit configured to add additional data being data in which the selected unlabeled data is associated with an object variable acquired from an oracle for the unlabeled data, to the training data.

3. The machine learning model generation system according to claim 1, wherein the machine learning model generation system repeatedly executes a series of processing of generating the trained model by the training execution unit, classifying the group by the grouping unit, selecting the group by the group selection unit, and setting the candidate model by the candidate model set setting unit, until a number of the candidate models becomes a predetermined number or less.

4. The machine learning model generation system according to claim 2, wherein the machine learning model generation system repeatedly executes a series of processing of generating the trained model by the training execution unit, classifying the group by the grouping unit, selecting the group and selecting the specific unlabeled data by the group selection unit, adding the additional data to the training data by the data addition unit, and setting the candidate model by the candidate model set setting unit, until a number of the candidate models becomes a predetermined number or less.

5. The machine learning model generation system according to claim 1, wherein the candidate model set setting unit sets the candidate model so that only the trained model belonging to the group selected by the group selection unit becomes the candidate model.

6. The machine learning model generation system according to claim 1, wherein the candidate model set setting unit adds the trained model belonging to the group selected by the group selection unit, as the candidate model.

7. The machine learning model generation system according to claim 1, wherein
the index is an average value of inference accuracy of the trained model belonging to the group, and
the group selection unit selects a predetermined number of the groups in descending order of the average value.

8. The machine learning model generation system according to claim 1, wherein the similarity is any one of mutual information, Kullback-Leibler information, and Jensen-Shannon information.

9. The machine learning model generation system according to claim 2, wherein
the index is an amount of increase in the inference accuracy of the trained model belonging to the group by adding the additional data as the training data, and
the group selection unit selects a predetermined number of the groups in descending order of the amount of increase.

10. A machine learning model generation method implemented by an information processing device comprising:
storing training data and a plurality of candidate models being machine learning models to be selection candidates;
performing machine learning by having the training data input into the candidate models to generate a plurality of trained models being trained machine learning models;
classifying the trained models into a plurality of groups based on similarity of an inference result output by each of the trained models;
generating an index used to select the group for each of the groups and selecting the group based on the index that is generated; and
setting the trained model belonging to the group that is selected, as the candidate model.

11. The machine learning model generation method according to claim 10, further comprising:
storing a plurality of pieces of unlabeled data;
selecting a specific piece of unlabeled data from the plurality of pieces of unlabeled data by performing active learning on the trained model belonging to the selected group; and
performing processing of adding additional data being data in which the selected unlabeled data is associated with an object variable acquired from an oracle for the unlabeled data, to the training data.

12. The machine learning model generation method according to claim 10, comprising:
repeatedly executing a series of processing of the generating of the trained model, the classifying of the group, the selecting of the group, and the setting of the candidate model, until a number of the candidate models becomes a predetermined number or less.

13. The machine learning model generation method according to claim 11, comprising:
repeatedly executing a series of processing of the generating of the trained model, the classifying of the group, the selecting of the group, the selecting of the specific unlabeled data, the adding of the additional data to the training data, and the setting of the candidate model, until a number of the candidate models becomes a predetermined number or less.

14. The machine learning model generation method according to claim 10, further comprising:
setting the candidate model so that only the trained model belonging to the group that is selected becomes the candidate model.

15. The machine learning model generation method according to claim 10, further comprising:
adding the trained model belonging to the group that is selected, as the candidate model.
